(19) United States
(12) Patent Application Publication
(10) Pub. No.: US 2010/0139303 A1
(43) Pub. Date: Jun. 10, 2010

(54) ELECTRICAL REFRIGERATOR WITH VACUUM PRESERVING SYSTEM AND CORRESPONDING CONTROL METHOD

(75) Inventors: Junhong Feng, Anhui Province (CN); Zongquan Suan, Nanjing (CN); Xiaotian Zhou, Ottobrunn (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/310,215

(22) PCT Filed: Aug. 8, 2007
(86) PCT No.: PCT/EP2007/058236

§ 371 Date: Feb. 25, 2010

(30) Foreign Application Priority Data
Aug. 18, 2006 (CN) 200610041376.2

(51) Int. Cl. F25B 41/00; G05B 15/00

(52) U.S. Cl. 62/268; 700/275

(57) ABSTRACT

An electric refrigerator includes a vacuum preservation system. The electric refrigerator includes a refrigerator body with a refrigeration compartment, and a vacuum preservation system inside the refrigerator body. The vacuum preservation system includes a vacuum preservation container inside the refrigeration compartment, a vacuum generation device for building up a vacuum in the vacuum preservation container, a control device for controlling a buildup in the vacuum, and a measuring and monitoring device for measuring and monitoring an operating state of the vacuum preservation system.

### TECHNICAL FIELD

The present invention relates to an electric refrigerator, in particular an electric refrigerator with vacuum preservation system, and to a method for controlling the electric refrigerator in question.

### GENERAL PRIOR ART

It is generally known that foodstuffs can be preserved for a longer period of time by cool storage or by storage at temperatures below freezing. In this case the length of time for which the foodstuffs are stored not only depends on the temperature and humidity of the respective environment, but is also subject to, for example, the effect of the oxygen content of the ambient air and the bacteria concentration of the ambient air. In order to achieve an extension of the length of time for which the foodstuffs can be stored, efforts are directed at creating a storage environment for foodstuffs that has a low oxygen content and low bacteria content—vacuum preservation containers, for example.

A vacuum preservation container in the refrigeration compartment of an electric refrigerator is proposed in the European patent EP0405680A2. The aforesaid vacuum preservation container is shown in FIG. 1. Said vacuum preservation container has a container body 17 and, connected to the container body, a container cover 19 which can be opened. A suction nozzle 25 is provided on the rear side of the container body, the aforesaid suction nozzle matching an adapter 27 located on the rear wall of the refrigeration compartment of the electric refrigerator. When the door 12 of the electric refrigerator is closed and the vacuum pump is put into operation, the aforesaid suction nozzle and the aforesaid adapter are sucked tightly against each other and in this way a vacuum is built up in the vacuum preservation container. When the door 12 of the electric refrigerator is opened, the suction nozzle 25 separates from the adapter 27 because the door 12 of the electric refrigerator and the container body 18 are connected to each other. The vacuum preservation container is automatically filled with air through the suction nozzle 25. The shortcoming of the aforesaid technical design concept consists in the fact that when the door 12 of the electric refrigerator is opened, the vacuum preservation container is inevitably filled with air, with the result that no other option is left to the user. If the user merely wishes to open the door of the electric refrigerator—without wanting to fill the vacuum preservation container with air—this cannot be achieved by means of the aforesaid technical design concept.

A vacuum preservation container in the refrigeration compartment of an electric refrigerator is proposed in the Chinese patent ZL03245813.4 A. The aforesaid vacuum preservation container is shown in FIG. 2. In this case the vacuum preservation container and door of the electric refrigerator are designed independently of each other, such that the aforesaid shortcoming of the European patent EP0405680A2 has been overcome. However, the shortcoming of the aforesaid Chinese patent consists in the fact that the ball valve serving to fill the vacuum preservation container with air is mounted on the cover. A user wanting to open the vacuum preservation container must first turn the ball valve in order to equalize the pressure on the outside and inside of the vacuum preservation container. Only then can the cover be opened. This means that two operating steps are necessary for opening the vacuum preservation container, with the result that said technical design concept is not particularly advantageous. Furthermore, in the case of the aforesaid vacuum preservation system two vacuum preservation containers are provided which are connected to different branches of the vacuum generation line. Because no specific control device is provided for the purpose of opening and closing the vacuum generation line, there is no possibility in the case of the electric refrigerator of independently building up a vacuum in only one of the two vacuum preservation containers.

If incorrect operating states of the vacuum preservation system occur, there is no possibility, with the currently present design concept, of immediately reflecting incorrect operating states of said kind.

### CONTENT OF THE INVENTION

The object of the present invention consists in providing an electric refrigerator with vacuum preservation system, wherein the aforesaid electric refrigerator permits a relatively long storage and preservation of foodstuffs and is easy to operate.

A further object of the present invention consists in providing a method for controlling the electric refrigerator with aforesaid vacuum preservation system.

In order to realize the aforesaid objects, a practical embodiment of the present invention provides an electric refrigerator with vacuum preservation system which has a refrigerator body with refrigeration compartment as well as a vacuum preservation system provided inside the refrigerator body, wherein the aforesaid vacuum preservation system has at least one vacuum preservation container provided inside the aforesaid refrigeration compartment as well as a vacuum generation device for building up the vacuum in the aforesaid vacuum preservation container, a control device for controlling the vacuum buildup, and a measuring and monitoring device for measuring and monitoring the operating state of the aforesaid vacuum preservation system.

A further improvement of the present invention provides that the aforesaid vacuum generation device has a vacuum pump, a vacuum generation line connected to the vacuum pump, and an adapter provided at one end of the aforesaid vacuum generation line and connected to the aforesaid vacuum preservation container, wherein the aforesaid control device has a valve device for opening and closing the aforesaid vacuum generation line, as well as a key provided on the refrigerator body for starting up the aforesaid vacuum preservation system, and wherein the aforesaid measuring and monitoring device has a sensor device provided in the control device for the purpose of measuring and monitoring the vacuum level of the aforesaid vacuum preservation system, and wherein the aforesaid measuring and monitoring device additionally has an alarm device for signaling incorrect operating states of the aforesaid vacuum preservation system.

A practical embodiment of the present invention provides a control method for an electric refrigerator with vacuum preservation system, wherein the aforesaid vacuum preservation system has at least one vacuum preservation container as well as a vacuum generation device for building up the vacuum in the aforesaid vacuum preservation container, characterized in that the aforesaid control method has the method steps listed below:

Providing a control device for controlling the vacuum buildup;
providing a measuring and monitoring device for measuring and monitoring the operating state of the vacuum preservation system;
outputting a command of the control device in order to start the vacuum buildup in the vacuum preservation container by means of the vacuum generation device;
measuring and monitoring the vacuum level of the vacuum preservation system by means of the measuring and monitoring device;
deciding on the operating state of the vacuum generation device by the control device according to the feedback signals of the measuring and monitoring device.

A further improvement of the present invention provides that the method step of the control device's deciding on the operating state of the vacuum generation device according to the feedback signals of the measuring and monitoring device has the method steps listed below:

If, after the vacuum generation device has been in operation for a predetermined length of time, the measuring and monitoring device detects no change in the vacuum level of the vacuum preservation system, the control device stops the operation of the vacuum generation device and outputs an alarm signal in the event that the vacuum preservation system is not in the correct operating state.

If, after the vacuum generation device has been in operation for a predetermined length of time, the measuring and monitoring device detects a change in the vacuum level of the vacuum preservation system, the control device stops the operation of the vacuum generation device.

A further improvement of the present invention provides that the aforesaid vacuum preservation container is used for refrigerating devices with vacuum preservation system such as, for example, domestic refrigerators, wherein the aforesaid vacuum preservation container has a container body, a container cover removably provided on the aforesaid container body, a vacuum generation device, a vacuum elimination device, and a start device, wherein when the start device is operated, the container cover is removed from the container body and the aforesaid vacuum elimination device is triggered by pressure on the handle such that the pressure inside and outside the vacuum preservation container is equalized.

A further improvement of the present invention provides that the aforesaid start device is a movable handle, wherein, when the handle is operated, the container cover is lifted off from the container body and the aforesaid vacuum elimination device is triggered by pressure on the handle. The aforesaid vacuum elimination device can be a non-return valve, the aforesaid non-return valve being provided on the aforesaid container cover and underneath the aforesaid handle.

A further improvement of the present invention provides that the aforesaid vacuum generation device is a non-return valve provided at one end of the vacuum preservation container, while the aforesaid start device is provided at the corresponding other end of the vacuum preservation container. The vacuum generation device is provided on the container cover or on the container body and the start device is provided on the container cover or on the container body.

The advantages of the electric refrigerator according to the invention are listed below:

1. The vacuum preservation system provided in the electric refrigerator according to the invention extends the storage life of foodstuffs.
2. The control method for the vacuum preservation system of the electric refrigerator actually reflects the operating state of the vacuum generation device.
3. The vacuum preservation container of the vacuum preservation system can trigger the elimination of the vacuum simultaneously with the startup, thereby simplifying operation.

### EXPLANATION OF THE FIGURES

FIG. 1 shows an overview of a currently existing electric refrigerator with vacuum preservation system.

FIG. 2 shows an overview of another currently existing electric refrigerator with vacuum preservation system.

FIG. 3 shows an overview of a vacuum preservation system for an electric refrigerator according to a practical inventive embodiment.

FIG. 4 shows an overview of a vacuum preservation system for an electric refrigerator according to another practical inventive embodiment.

FIG. 5 shows an overview of the control method for an inventive electric refrigerator with vacuum preservation system.

FIG. 6 shows an overview of the sequence of the control method for an inventive electric refrigerator with vacuum preservation system.

FIG. 7 shows a three-dimensional view of the vacuum preservation container of the inventive vacuum preservation system of an electric refrigerator.

FIG. 8 shows a three-dimensional exploded view of the vacuum preservation container of the inventive vacuum preservation system of an electric refrigerator.

FIG. 9 shows a partial sectional view of an air non-return valve on the vacuum preservation container and handle of FIG. 7.

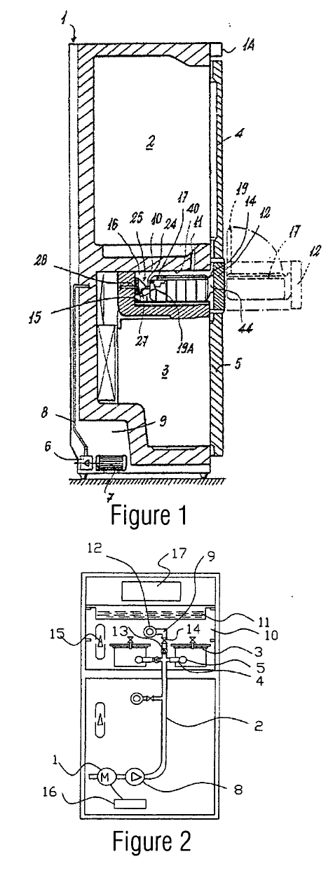

### PRACTICAL EMBODIMENTS

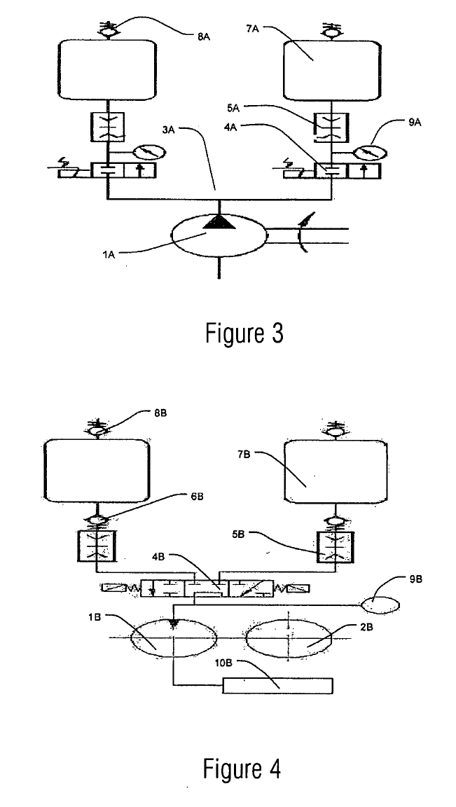

As can be seen from FIG. 3, an overview of a vacuum preservation system for an electric refrigerator according to a practical inventive embodiment is shown. The electric refrigerator is an electric domestic refrigerator employing cooling by means of a conventional cooling circuit. The electric refrigerator has a refrigerator body with refrigeration compartment and freezer compartment. The refrigerator body is provided with a thermal insulation. Since refrigerator body, refrigeration compartment and freezer compartment are part of the generally known prior art, no further explanations are necessary at this juncture with regard to their design.

As can be seen from FIG. 3, the inventive vacuum preservation system has a vacuum pump 1A, an electric motor for driving the aforesaid vacuum pump (not shown in the figure), as well as a vacuum generation line 3A and two two-position two-way valves 4A which serve as a control device for opening and closing the vacuum generation line 3A. The adapter 5A is additionally provided between the vacuum preservation container 7A and vacuum generation line 3A. A non-return valve 8A is provided on the vacuum preservation container 7A and serves as an air supply device. Opening and closing of the vacuum generation line 3A are controlled by means of the switch of the two-position two-way valves 4A. After the vacuum buildup for the vacuum preservation container 7A has been completed, the pressure in the vacuum preservation container is maintained by means of the two-position two-way valves 4A. A measuring and monitoring device 9A is also provided on the vacuum preservation container 7A and performs the measuring and monitoring of the vacuum level of the vacuum preservation system. In this case said device is, for example, a negative pressure sensor which is used as a vacuum sensor. In this way the vacuum level of the vacuum preservation system can be measured and monitored.

As can be seen from FIG. 4, in another practical embodiment of the present invention the inventive vacuum preservation system has a vacuum pump 1B, an electric motor 2B for driving the aforesaid vacuum pump, as well as a vacuum generation line 3B and a three-position four-way valve 4B which serves as a control device for opening and closing the vacuum generation line 3B. An adapter 5B is also provided. A non-return valve 6B, which serves as an air evacuation device, and a non-return valve 8B, which serves as an air supply device, are provided on the vacuum preservation container 7B. Opening and closing of the vacuum generation line 3B are controlled by means of the switch of the three-position four-way valve 4B. After the vacuum buildup for the vacuum preservation container 7B has been completed, the pressure in the vacuum preservation container is maintained by means of the three-position four-way valve 4B. A measuring and monitoring device 9B is also provided at the inlet to the vacuum pump 1B and performs the measuring and monitoring of the vacuum level of the vacuum preservation system. In this case said device is, for example, a continuous negative pressure sensor which is used as a vacuum sensor.

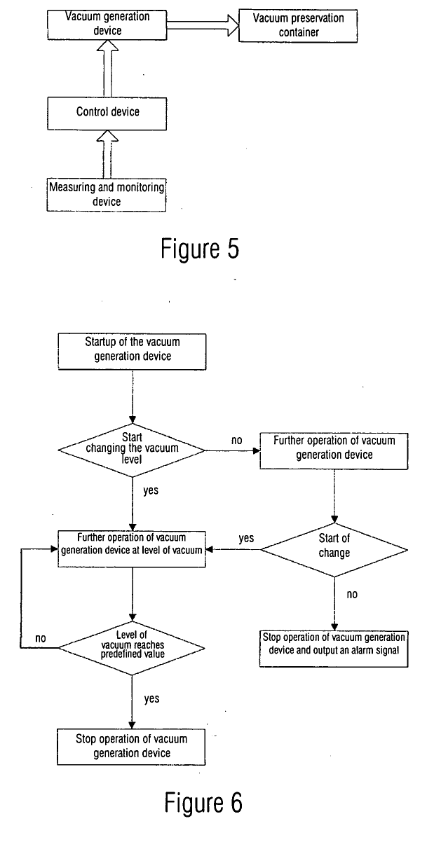

As can be seen from FIG. 5, the control system of the vacuum preservation system of the inventive electric refrigerator has a measuring and monitoring device, a control device and a vacuum generation device. The aforesaid measuring and monitoring device can be a measuring and monitoring device 9A provided on the vacuum preservation container 7A for the purpose of measuring and monitoring the vacuum level or a measuring and monitoring device 9B provided at the inlet of the vacuum pump 1B for the purpose of measuring and monitoring the vacuum level. The aforesaid measuring and monitoring device also has an alarm device for reporting incorrect operating states of the vacuum preservation system. The aforesaid alarm device can be a buzzer or an LED indicator lamp. The aforesaid alarm device can be provided outside on the door of the electric refrigerator or it can be provided on the internal wall of the refrigeration compartment. The aforesaid control device has two two-position two-way valves 4A, which serve as a control device for opening and closing the vacuum generation line 3A, or one three-position four-way valve 4B, which serves as a control device for opening and closing the vacuum generation line 3B. Also provided on the refrigerator body is a key for starting up the vacuum preservation system. The aforesaid key can be provided outside on the door of the electric refrigerator or it can be provided on the internal wall of the refrigeration compartment. The aforesaid vacuum generation device has a vacuum pump 1A, 1B, an electric motor 2A, 2B for driving the aforesaid vacuum pump, as well as a vacuum generation line 3A, 3B and adapter 5A, 5B.

As can be seen from FIG. 6, the method for controlling the vacuum preservation system of the inventive refrigerator has the method steps listed below:

Method step 1:

By actuating the key of the control system the user starts up the vacuum generation device and in this way initiates the vacuum buildup in the vacuum preservation container.

Method step 2:

The measuring and monitoring device begins measuring and monitoring changes with regard to the vacuum level of the vacuum preservation system.

Method step 3:

If the measuring and monitoring device establishes that changes have taken place with regard to the vacuum level of the vacuum preservation system, the control device ensures that the vacuum generation device continues in operation. The measuring and monitoring device carries on measuring and monitoring with regard to the vacuum level of the vacuum preservation system. If the measuring and monitoring device determines that the predetermined value of the vacuum level of the vacuum preservation system has been reached, the control device outputs a control signal so that the vacuum generation device will cease operation. The vacuum buildup in the vacuum preservation system is completed.

Method step 4:

If the measuring and monitoring device establishes that changes have not taken place with regard to the vacuum level of the vacuum preservation system, the control device ensures that the vacuum generation device continues in operation for a predetermined period of time (approximately two minutes). If the measuring and monitoring device then determines that still no change has taken place with regard to the vacuum level of the vacuum preservation system, the control device outputs a control signal so that the vacuum generation device will cease operation. At the same time a signal is output by the alarm device indicating that the vacuum preservation system is not in the correct operating state.

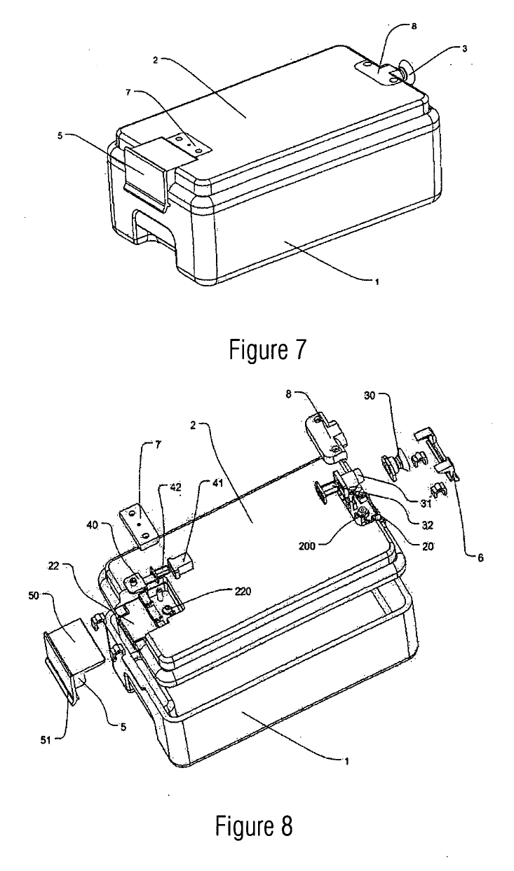

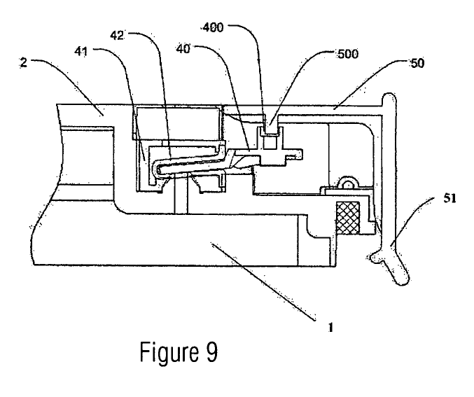

After the vacuum for the vacuum preservation container 1A, 1B of the vacuum preservation system has been built up, the vacuum state of the vacuum preservation container 1A, 1B can be maintained for a relatively long period of time. The user can release the vacuum state of the vacuum preservation container manually. FIGS. 7 to 9 show a vacuum preservation container which can be opened in a simple manner by the user.

As can be seen from FIGS. 7 to 9, the vacuum preservation container of a practical embodiment of the present invention has a container body 1, a container cover 2, a handle 5 provided at one end of the container cover 2, an air supply non-return valve 4 provided underneath the handle 5, a locking part 6 provided at the other corresponding end of the container cover 2, and an air evacuation non-return valve 3. The handle 5 and locking part 6 connect the container body 1 and container cover 2 to each other. In the present practical embodiment, the air supply non-return valve 4 is a vacuum elimination device. Positioning in the recess 22 which is located at one end of the container cover 2 is accomplished by means of the front positioning element 7. The air evacuation non-return valve 3 is the vacuum elimination device. Positioning in the recess 20 which is located at the other end of the container cover 2 is accomplished by means of the rear positioning element 8. In other practical embodiments of the present invention, the vacuum generation device and the vacuum elimination device can also be other elements or switching devices. It is merely necessary for said devices to be able to perform the vacuum buildup or, as the case may be, vacuum elimination of the vacuum preservation container in a predetermined direction.

The air evacuation non-return valve 3 has an adapter part 30, a connecting part 31 and an internal valve part (plug) 32, wherein the adapter part 30 matches the adapter of the outer vacuum generation line, while the connecting part 31 matches the adapter opening 200 located in the recess 20 and the internal valve part (plug) 32 is inserted into the connecting part 31. When the internal valve part (plug) 32 is subjected to pressure, the air evacuation non-return valve 3 opens and the air present in the vacuum preservation container is evacuated out of the vacuum generation line through the adapter opening 200. The rear positioning element 8 is provided above the connecting part 31. Two connecting holes provided spaced apart are located thereon. The rear positioning element 8 is secured in the recess 20 of the container cover 2 through the aforesaid connecting holes. One end of the locking part 6 is connected to the recess 20, while the other end is secured at the edge of the container body 1. In this way the container body 1 and one end of the container cover 2 are connected to each other. The locking part 6 can be removed from the vacuum preservation container by tilting the end of the locking part 6 connected to the container body 1.

The air supply non-return valve 4 has an arm part 40, a connecting part 41 and an internal valve part (plug) 42. During assembly, one end of the arm part 40 is inserted into the internal valve part (plug) 42. The internal valve part (plug) 42 is in turn inserted into the connecting part 41. The connecting part 41 matches the adapter opening 220 provided in the recess 22. The front positioning element 7 is provided above the connecting part 41. Two connecting holes provided spaced apart are located thereon. The front positioning element 7 is secured in the recess 22 of the container cover 2 through the aforesaid connecting holes. The handle 5 is movably connected to the edge of the recess 22 and can be rotated against the container cover 2. The handle 5 has a handle part 51 bent approximately at right angles, as well as a pressure part 50, the pressure part 50 being located above the arm part 40 of the air supply non-return valve 4. The projection 500 of the handle part 51 corresponds to the pocket 400 on the arm part 40. The bottom end of the handle part 51 can terminate with the edge at one end of the container body 1.

When the vacuum preservation container is opened under vacuum, a tilting of the handle part 51 of the handle 5 ensures that the handle 5 rotates about the edge of the container cover 2. At this time the pressure part 50 experiences pressure and transfers the pressure via the projection 500 to the arm part 40 of the air supply non-return valve 4. The end of the arm part 40 to which pressure is applied moves downward and the part of the arm part 40 located in the internal valve part (plug) 42 moves upward, such that the adapter opening 220 closed by means of the internal valve part (plug) 42 in the recess 22 is opened. The external air is routed through the adapter opening 220 into the interior of the vacuum preservation container. Thus, the container cover 2 can be removed from the container body 1 by tilting the handle.

A comparison with the currently existing prior art reveals that with the present invention the vacuum preservation container can be simultaneously opened and the vacuum eliminated with one movement by tilting the handle 5. This leads to a simplification of its operation and makes using it more practical. Furthermore, the air supply non-return valve 4 is positioned in a concealed manner, such that the external appearance of the vacuum preservation container is more visually attractive.

With the present practical embodiment, both the air evacuation non-return valve 3 and the air supply non-return valve 4 are provided on the container cover 2. In other embodiments, the vacuum generation device and vacuum elimination device are both provided on the container body 1 or, alternatively, one of them is provided on the container body and the other on the container cover. The object of the present invention is achieved with each of the aforesaid variants.

1-18. (canceled)

19. An electric refrigerator with a vacuum preservation system, the electric refrigerator comprising:
a refrigerator body with a refrigeration compartment; and
a vacuum preservation system inside the refrigerator body, the vacuum preservation system comprising:
a vacuum preservation container inside the refrigeration compartment;
a vacuum generation device for building up a vacuum in the vacuum preservation container;
a control device for controlling a buildup in the vacuum; and
a measuring and monitoring device for measuring and monitoring an operating state of the vacuum preservation system.

20. The electric refrigerator of claim 19, wherein the vacuum generation device comprises:
a vacuum pump;
a vacuum generation line connected to the vacuum pump; and
an adapter at an end of the vacuum generation line and connected to the vacuum preservation container.

21. The electric refrigerator of claim 20, wherein the control device has a valve device for opening and closing the vacuum generation line and a key on the refrigerator body for starting up the vacuum preservation system.

22. The electric refrigerator of claim 19, wherein the measuring and monitoring device has a sensor device in the control device for measuring and monitoring the vacuum level of the vacuum preservation system.

23. The electric refrigerator of claim 22, wherein the measuring and monitoring device has an alarm device for signaling an incorrect operating state of the vacuum preservation system.

24. The electric refrigerator of claim 19, wherein the vacuum preservation container comprises:
a container body;
a container cover;
an air valve connected to the vacuum generation device; and
an air valve for a vacuum elimination state on the container cover.

25. The electric refrigerator of claim 24, wherein the vacuum preservation container has a handle for lifting off the container lid from the container body and for placing the air valve for the vacuum elimination state into operation and opening the vacuum preservation container when the handle is operated.

26. A control method for an electric refrigerator with vacuum preservation system having a vacuum preservation container and a vacuum generation device for building up a vacuum in the vacuum preservation container, the method comprising:
outputting a command from a control device to start a vacuum buildup in the vacuum preservation container with the vacuum generation device;
measuring and monitoring a vacuum level of the vacuum preservation system with a measuring and monitoring device;
deciding on an operating state of the vacuum generation device by the control device according to the vacuum level measured by the measuring and monitoring device.

27. The control method of claim 26, wherein deciding on the operating state of the vacuum generation device according to the vacuum level measured by the measuring and monitoring device comprises:
stopping operation of the vacuum generation device and outputting an alarm signal if the vacuum generation device has been in operation for a predetermined length of time and the measuring and monitoring device detects no change in the vacuum level of the vacuum preservation system; and
stopping operation of the vacuum generation device if the vacuum generation device has been in operation for a predetermined length of time and the measuring and monitoring device detects a change in the vacuum level of the vacuum preservation system.

28. The control method of claim 26, wherein the vacuum generation device comprises:
a vacuum pump;
a vacuum generation line connected to the vacuum pump; and
an adapter at an end of the vacuum generation line and connected to the vacuum preservation container.

29. The control method of claim 28, wherein the control device comprises:
a valve device for opening and closing the vacuum generation line; and
a key on the refrigerator body for starting up the vacuum preservation system.

30. The control method of claim 29, wherein the measuring and monitoring device comprises a sensor device in the control device for measuring and monitoring the vacuum level of the vacuum preservation system.

31. The control method of claim 30, wherein the measuring and monitoring device further comprises an alarm device for signaling an incorrect operating state of the vacuum preservation system.

32. A vacuum preservation container for a refrigerating device having a vacuum preservation system, the vacuum preservation container comprising:
a start device
a container body;
a container cover removably provided on the container body that is removed from the container body when the start device is operated;
a vacuum generation device; and
a vacuum elimination device that is triggered by a pressure on a handle to equalize pressure on the inside and outside of the vacuum preservation container.

33. The vacuum preservation container of claim 32, wherein the vacuum generation device comprises a non-return valve at an end of the vacuum preservation container, and wherein the start device is on a corresponding other end of the vacuum preservation container.

34. The vacuum preservation container of claim 32, wherein the start device comprises the handle which causes the container cover to lift off from the container body and the trigger of the vacuum elimination device by the pressure on the handle.

35. The vacuum preservation container of claim 34, wherein the vacuum elimination device comprises a non-return valve.

36. The vacuum preservation container of claim 35, wherein the handle is movably connected to the container cover and the non-return valve is on the container cover and underneath the handle.
